(19) United States
(12) Patent Application Publication
(10) Pub. No.: US 2026/0214192 A1
(43) Pub. Date: Jul. 23, 2026

(54) ILLUMINATION SYSTEM AND PROJECTION DEVICE

(71) Applicant: Coretronic Corporation, Hsin-Chu (TW)

(72) Inventor: Yu-Hsiang Deng, Hsin-Chu (TW)

(73) Assignee: Coretronic Corporation, Hsin-Chu (TW)

(21) Appl. No.: 19/445,614

(22) Filed: Jan. 11, 2026

(30) Foreign Application Priority Data
Jan. 21, 2025 (CN) 202510091035.9

(51) Int. Cl. H04N 9/31; G02B 19/00; G02B 26/00; G02B 27/14; G02B 27/28; G03B 21/20

(52) U.S. Cl. CPC H04N 9/3197; G02B 19/0052; G02B 26/007; G02B 27/141; G02B 27/283; G03B 21/2066; H04N 9/3161; H04N 9/3164

(57) ABSTRACT

An illumination system includes a light source module, a wavelength conversion element, a light path switching module, a first beam splitting element, and a second beam splitting element. The light source module is configured to emit first color light, second color light, and third color light. The light path switching module is configured to cause the first color light to pass through during a first time interval, and reflect the first color light during a second time interval. The first beam splitting element is configured to cause the second color light and the third color light to pass through, and reflect the first color light. The first color light is transmitted towards a first direction to the light path switching module, and the second color light and the third color light are transmitted towards a second direction to the first beam splitting element. A projection device is also proposed.

### CROSS-REFERENCE TO RELATED APPLICATION

This application claims the priority benefit of China application serial no. 202510091035.9, filed on January 21, 2025. The entirety of the above-mentioned patent application is hereby incorporated by reference herein and made a part of this specification.

### BACKGROUND

### TECHNICAL FIELD

This disclosure relates to an optical system, and particularly relates to an illumination system and a projection device.

### DESCRIPTION OF RELATED ART

With the evolution of projection technology, projection devices capable of projecting high-brightness image pictures have been developed. Compared to traditional projection devices, high-brightness projection devices may allow users to see the displayed picture clearly even under higher ambient brightness conditions.

Generally, high-brightness projection devices use lasers as light sources. However, when using red, blue, and green pure lasers as light sources, there may be problems with laser speckle and brightness limited by packaging. Therefore, combining three-color pure laser sources with phosphor wheel technology may to some extent solve the aforementioned problems.

However, since the phosphor region and non-phosphor region of the phosphor wheel need to be irradiated by the laser sequentially, in a time-sequential projection device using a rotating phosphor wheel, due to the limitation of the slower rotation speed of the phosphor wheel, it usually leads to the phenomenon of color breaking. That is, when the rotation speed of the phosphor wheel is slower, there are fewer color switching cycles per unit time, resulting in the human eye perceiving rainbow patterns. However, if the rotation speed of the phosphor wheel is increased to reduce the problem of color breaking, the noise generated by the phosphor wheel and its driving motor may become excessive. If the noise specification limit is to be maintained, the radius of the phosphor wheel needs to be reduced, which may make the area of the phosphor smaller and worsen heat dissipation. The light spot irradiated on the phosphor also needs to be designed smaller, thereby deteriorating optical efficiency.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

One embodiment of this disclosure proposes an illumination system, including a light source module, a wavelength conversion element, a light path switching module, a first beam splitting element, and a second beam splitting element. The light source module is configured to emit first color light, second color light, and third color light, where dominant wavelengths of the first color light, the second color light, and the third color light are different from each other. The wavelength conversion element has an O-shaped ring phosphor element. The light path switching module is configured to cause the first color light to pass through during a first time interval, and reflect the first color light during a second time interval, where the first time interval and the second time interval do not overlap. The first beam splitting element is configured to cause the second color light and the third color light to pass through, and reflect the first color light. The first color light is transmitted towards a first direction to the light path switching module, and the second color light and the third color light are transmitted towards a second direction to the first beam splitting element. After passing through the light path switching module, the first color light irradiates the wavelength conversion element to generate excited light. After being reflected by the light path switching module, the first color light is transmitted to the first beam splitting element, and does not irradiate the wavelength conversion element. The second beam splitting element is configured to cause the excited light to pass through, and reflect the first color light, the second color light, and the third color light.

One embodiment of this disclosure proposes a projection device, including the aforementioned illumination system, a light valve, and a projection lens. The light valve is disposed on light paths of first color light, excited light, second color light, and third color light, and is configured to convert the first color light, the excited light, the second color light, and the third color light into an image beam. The projection lens is disposed on a light path of the image beam.

Other objectives, features and advantages of the disclosure will be further understood from the further technological features disclosed by the embodiments of the disclosure wherein there are shown and described preferred embodiments of this disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1A is a schematic diagram of a light path of a projection device according to an embodiment of this disclosure during a first time interval.

FIG. 1B is a schematic diagram of the light path of the projection device of FIG. 1A during a second time interval.

FIG. 2A is a side view schematic diagram of a light source module of FIG. 1A viewed along the +x direction.

FIG. 2B is a cross-sectional view schematic diagram of the light source module of FIG. 1A viewed along the +y direction, which is a cross-sectional view schematic diagram along the I-I line of FIG. 2A.

FIG. 3 is a front view schematic diagram of a light path switching module of FIG. 1A and FIG. 1B.

FIG. 4 is a front view schematic diagram of a wavelength conversion element of FIG. 1A viewed along the +x direction.

FIG. 5 is a timing diagram of an illumination system in FIG. 1A and FIG. 1B.

FIG. 6 is a side view schematic diagram of a light source module according to another embodiment of the disclosure viewed along the -z direction.

FIG. 7A is a schematic diagram of a light path of a projection device according to another embodiment of the disclosure during the first time interval.

FIG. 7B is a schematic diagram of the light path of the projection device of FIG. 7A during the second time interval.

FIG. 8 is a comparative schematic diagram of a light path switching module in FIG. 7A and the light path switching module in FIG. 1A.

FIG. 9A is a schematic diagram of a light path of a projection device according to another embodiment of the disclosure during the first time interval.

FIG. 9B is a schematic diagram of the light path of the projection device of FIG. 9A during the second time interval.

FIG. 10 is a front view schematic diagram of a rotating element in FIG. 9A and FIG. 9B.

FIG. 11A and FIG. 11B are schematic diagrams of a first color light beam in FIG. 9A illuminating a central region and an edge region of a sub-region, respectively.

FIG. 12 is a front view schematic diagram of the rotating element in FIG. 9A and FIG. 9B according to another embodiment.

### DESCRIPTION OF THE EMBODIMENTS

In the following detailed description of the preferred embodiments, reference is made to the accompanying drawings which form a part hereof, and in which are shown by way of illustration specific embodiments in which the disclosure may be practiced. In this regard, directional terminology, such as “top,” “bottom,” “front,” “back,” etc., is used with reference to the orientation of the Figure(s) being described. The components of the present disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

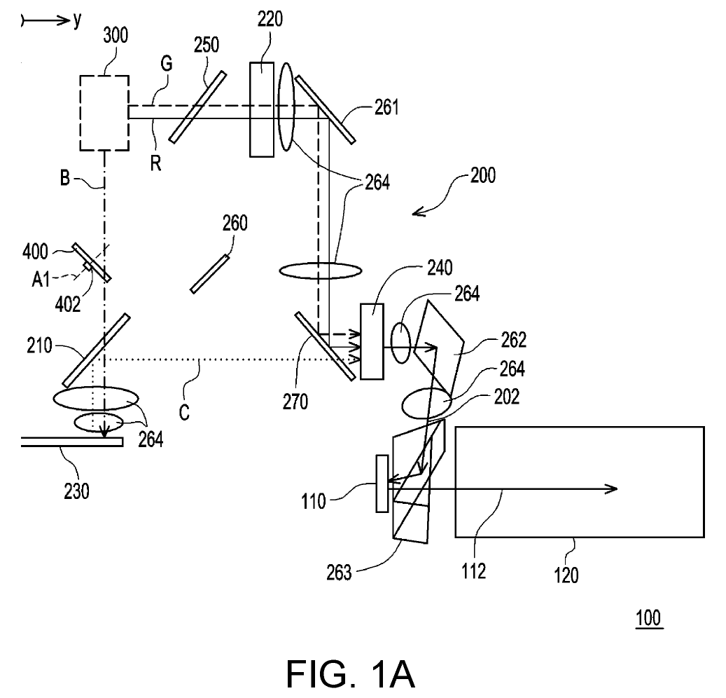

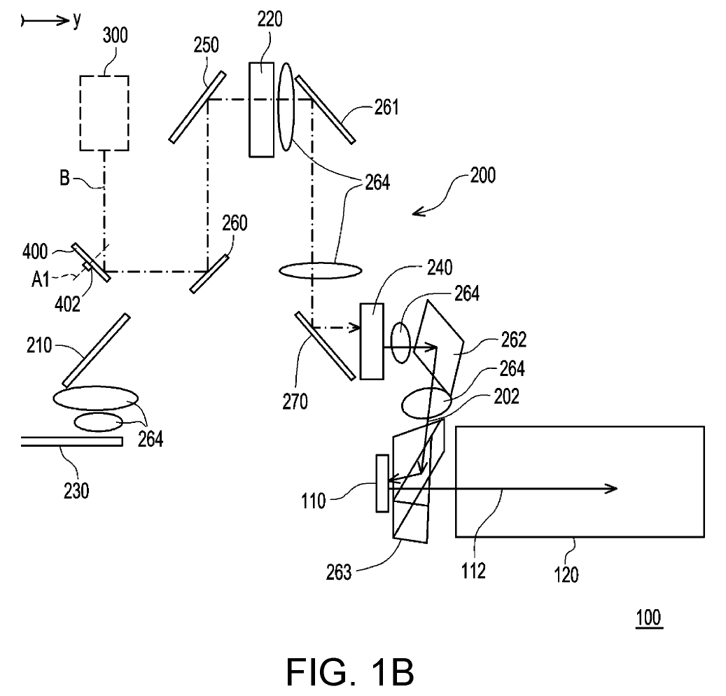

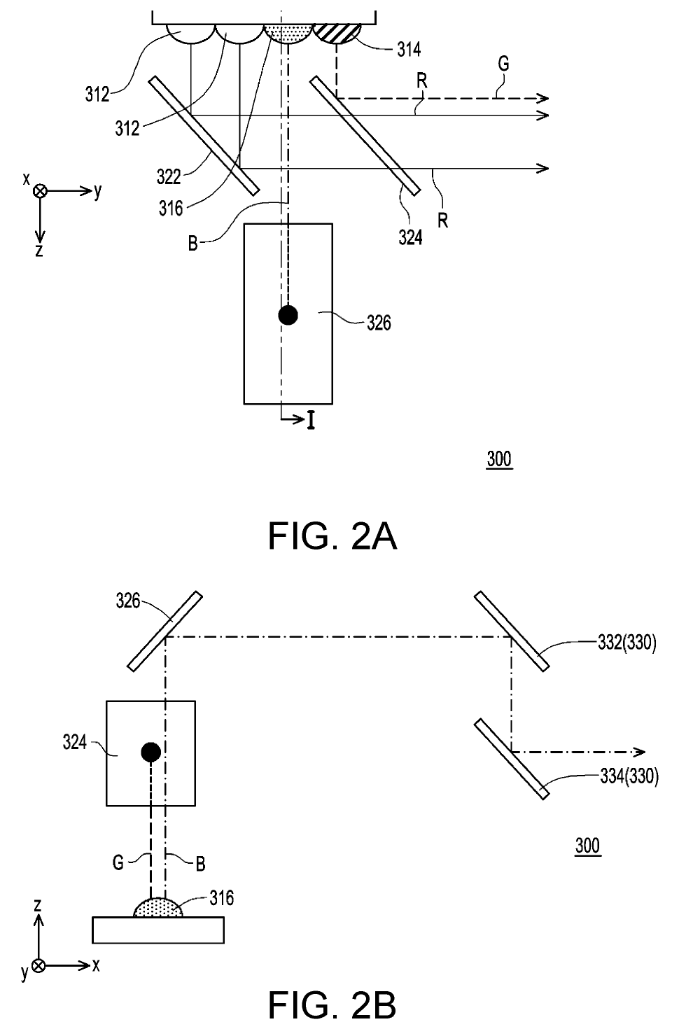

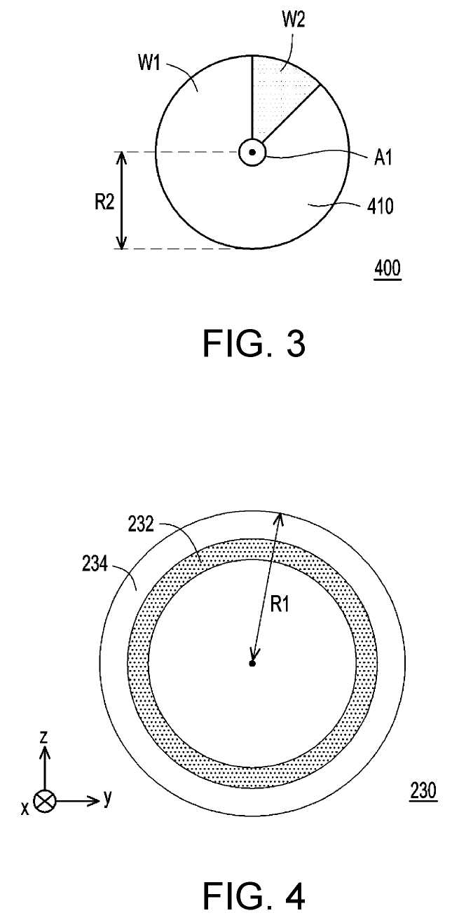

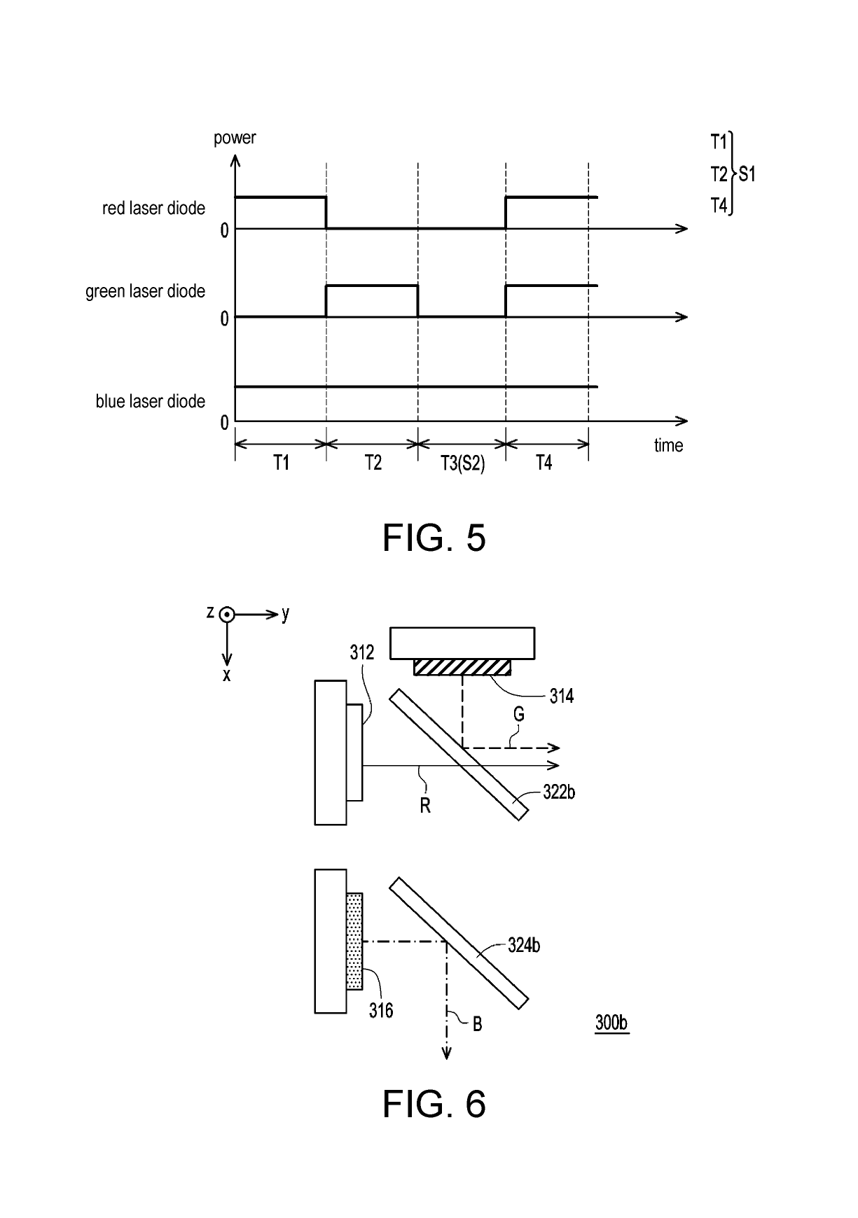

FIG. 1A is a schematic diagram of a light path of a projection device according to an embodiment of this disclosure during a first time interval. FIG. 1B is a schematic diagram of the light path of the projection device of FIG. 1A during a second time interval. FIG. 2A is a side view schematic diagram of a light source module of FIG. 1A viewed along the +x direction. For the sake of clarity and simplicity, the illustration of a reflector group is omitted in FIG. 2A. FIG. 2B is a cross-sectional view schematic diagram of the light source module of FIG. 1A viewed along the +y direction, which is a cross-sectional view schematic diagram along the I-I line of FIG. 2A. FIG. 3 is a front view schematic diagram of a light path switching module of FIG. 1A and FIG. 1B. FIG. 4 is a front view schematic diagram of a wavelength conversion element of FIG. 1A viewed along the +x direction. FIG. 5 is a timing diagram of an illumination system in FIG. 1A and FIG. 1B.

Please refer to FIG. 1A, FIG. 1B, FIG. 2A, FIG. 2B, FIG. 3, FIG. 4 and FIG. 5. A projection device 100 of this embodiment includes an illumination system 200, a light valve 110, and a projection lens 120. The illumination system 200 is configured to provide an illumination beam 202, and the illumination system 200 includes a light source module 300, a light path switching module 400, a wavelength conversion element 230, a first beam splitting element 250, and a second beam splitting element 270. The light source module 300 is configured to emit a first color light B, a second color light R and a third color light G. The dominant wavelengths of the first color light B, the second color light R, and the third color light G are different from each other. The wavelength conversion element 230 possesses an O-shaped ring phosphor element 232. The light path switching module 400 is configured to cause the first color light B to pass through during a first time interval S1 (as shown in FIG. 1A), and reflect the first color light B during a second time interval S2 (as shown in FIG. 1B), where the first time interval S1 and the second time interval S2 do not overlap.

The first beam splitting element 250 is configured to cause the second color light R and the third color light G to pass through, and reflect the first color light B. The first color light B is transmitted towards a first direction (for example, the x direction in FIG. 1A) to the light path switching module 400, the second color light R and the third color light G are transmitted towards a second direction (for example, the y direction in FIG. 1A) to the first beam splitting element 250, wherein the first direction is different from the second direction.

During the first time interval S1, after passing through the light path switching module 400, the first color light B irradiates the wavelength conversion element 230 and generates excited light C. During the second time interval S2, after being reflected by the light path switching module 400, the first color light B is transmitted to the first beam splitting element 250, and does not irradiate the wavelength conversion element 230.

The second beam splitting element 270 is configured to cause the excited light C to pass through, and reflect the first color light B, the second color light R, and the third color light G. In this embodiment, after the action of the second beam splitting element 270, the excited light C, the first color light B, the second color light R, and the third color light G possess the same light path and transmission direction.

In this embodiment, as shown in FIG. 2A, a light source module 300 includes at least one red laser diode 312, at least one green laser diode 314, and at least one blue laser diode 316 located within the same package. FIG. 2A exemplifies two red laser diodes 312, one green laser diode 314, and one blue laser diode 316, but this disclosure is not limited to this. The blue laser diode 316 is configured to emit the first color light B, the red laser diode 312 is configured to emit the second color light R, and the green laser diode 314 is configured to emit the third color light G. In this embodiment, the light source module 300 also includes a first reflector 322, a color separation mirror 324, and a second reflector 326. The first reflector 322 and the color separation mirror 324 are configured to cause the second color light R and the third color light G to be emitted towards the second direction (i.e., +y direction). In this embodiment, the original emission direction of the blue laser diode 316, the red laser diode 312, and the green laser diode 314 is the +z direction. Subsequently, the second color light R is reflected by the first reflector 322 and transmitted towards the +y direction to the color separation mirror 324, then passes through the color separation mirror 324 and continues to be transmitted towards the +y direction. In addition, the third color light G is also transmitted towards the +y direction after being reflected by the color separation mirror 324.

The second reflector 326 is configured to cause the first color light B to be emitted towards the first direction (i.e., +x direction). However, due to the limitations of optical element arrangement, the height difference in the z direction between the first color light B reflected by the second reflector 326 and the second color light R transmitted towards the +y direction is relatively large. Therefore, as shown in FIG. 2B, the light source module 300 also includes a reflector group 330 configured to cause the first color light B from the second reflector 326 to translate. Specifically, in this embodiment, the reflector group 330 may include a reflective mirror 332 and a reflective mirror 334. The reflective mirror 332 reflects the first color light B from the second reflector 326 towards the -z direction, while the reflective mirror 334 then reflects the first color light B from the reflective mirror 332, to cause the first color light B to be transmitted again towards the +x direction. In this embodiment, the x direction, y direction, and z direction are perpendicular to each other, but this disclosure is not limited to this.

The light path switching module 400 is disposed on the transmission path of the first color light B from the light source module 300 (for example, the reflective mirror 334). The light path switching module 400 includes a transmissive region W1 configured to cause the first color light B to pass through and a reflective region W2 configured to reflect the first color light B. In this embodiment, the light path switching module 400 is a rotatable wheel that may rotate around an axis A1 driven by a motor 402. During a first time interval S1, the transmissive region W1 enters the light path of the first color light B and causes the first color light B to pass through and to be transmitted to the wavelength conversion element 230. During a second time interval S2, the reflective region W2 enters the light path of the first color light B and causes the first color light B to reflect and to be transmitted to the first beam splitting element 250, meaning that during the second time interval S2, the first color light B is not transmitted to the wavelength conversion element 230.

In this embodiment, the first color light B may be a blue light beam, the second color light R may be a red light beam, and the third color light G may be a green light beam, but this disclosure is not limited to this. The wavelength conversion element 230 is configured to convert the first color light B into an excited light C. In this embodiment, the excited light C may be a yellow light beam. However, in other embodiments, the excited light C may also be a green light beam, a red light beam, or a combination thereof.

In this embodiment, the wavelength conversion element 230 is a moving part, for example, the wavelength conversion element 230 is a rotating wheel with an O-shaped ring phosphor element 232. The first color light B transmitted to the wavelength conversion element 230 irradiates on the phosphor element 232 and is converted to the excited light C. Since the illumination system 200 possesses the light path switching module 400 to switch whether the first color light B is transmitted to the wavelength conversion element 230, the phosphor element 232 may be a complete continuous ring disposed on the surface of the rotating wheel (ring-shaped phosphor), and the light path switching module 400 of the illumination system 200 may switch the transmission direction of the first color light B. Therefore, the rotation speed of the rotating wheel of the wavelength conversion element 230 may not need to correspond to the refreshing speed of the image color, so the rotation speed of the rotating wheel of the wavelength conversion element 230 may be appropriately reduced (only needing to consider issues related to heat accumulation and dissipation of the wavelength conversion element 230), thereby effectively suppressing the noise of the rotating wheel. In this embodiment, the phosphor element 232 may be yellow phosphor. However, in other embodiments, the phosphor element 232 may also be red phosphor, green phosphor, or a combination thereof.

In this embodiment, to cause various light beams to be transmitted towards predetermined directions, the illumination system 200 may further include other optical elements, but this disclosure is not limited to this. For example, the illumination system 200 may further include a third beam splitting element 210 located between the wavelength conversion element 230 and the light path switching module 400. The third beam splitting element 210 is configured to cause one of the first color light B and the excited light C to pass through, and reflect the other of the first color light B and the excited light C. In FIG. 1A, for example, the third beam splitting element 210 causes the first color light B to pass through and reflects the excited light C.

The illumination system 200 may further include a first homogenizing element 220 and a second homogenizing element 240. The first homogenizing element 220 is disposed on the transmission paths of the first color light B, the second color light R, and the third color light G from the first beam splitting element 250. The second homogenizing element 240 is disposed on the transmission paths of the first color light B, the second color light R, the third color light G, and the excited light C from the second beam splitting element 270.

Specifically, the first beam splitting element 250 is configured to reflect the first color light B and allow the second color light R and the third color light G to pass through, in order to transmit both the first color light B reflected by the light path switching module 400 and the second color light R and third color light G from the light source module 300 to the first homogenizing element 220. The illumination system 200 may also include a reflective mirror 260 disposed on the light path between the light path switching module 400 and the second beam splitting element 250. The reflective mirror 260 is configured to reflect the first color light B reflected by the light path switching module 400 to the first beam splitting element 250. The second beam splitting element 270 is disposed on the light path between the first beam splitting element 250 and the second homogenizing element 240, configured to allow the excited light C from the third beam splitting element 210 to pass through and be transmitted to the second homogenizing element 240, and configured to reflect the first color light B, the second color light R, and the third color light G from the first homogenizing element 220. The illumination system 200 may also include a reflective mirror 261, configured to reflect the first color light B, the second color light R, and the third color light G from the first homogenizing element 220 to the second beam splitting element 270. The third beam splitting element 210, the first splitting element 250, and the second beam splitting element 270 may be dichroic mirrors, for example, while the first homogenizing element 220 and the second homogenizing element 240 may be light integrating rods, lens arrays, or other optical elements with light homogenizing effects. In this embodiment, the first homogenizing element 220 and the second homogenizing element 240 may be lens arrays, for example. The first homogenizing element 220 is configured to solve the problem of laser speckle. The second homogenizing element 240 is configured to adjust the light shape of the first color light B, the second color light R, the third color light G, and the excited light C to match the shape of light incident surface (e.g., rectangle) of the light valve 110. In other embodiments, the illumination system 200 may also include only a single homogenizing element disposed on the transmission path of the first color light B, the second color light R, the third color light G, and the excited light C.

In this embodiment, the light valve 110 is disposed on the light path of the first color light B, the excited light C, the second color light R, and the third color light G, and is configured to convert the first color light B, the excited light C, the second color light R, and the third color light G into an image light beam 112. In other words, the light valve 110 is disposed on the transmission path of the illumination beam 202, and is configured to convert the illumination beam 202 into an image light beam 112. The illumination beam 202 includes at least one of the first color light B, the excited light C, the second color light R, and the third color light G from the second homogenizing element 240. The projection lens 120 is disposed on the transmission path of the image light beam 112, and is configured to project the image light beam 112 out of the projection device 100 to form a projected image.

In addition, the illumination beam 202 from the second homogenizing element 240 may be reflected by the reflective mirror 262 to the total internal reflection prism group 263, and transmitted to the light valve 110 via the total internal reflection prism group 263. The light valve 110 may be, for example, a digital micro-mirror device (DMD), a liquid-crystal-on-silicon panel (LCOS panel), or any other appropriate spatial light modulator, which may modulate the illumination beam 202 into an image light beam 120. The image light beam 120 is then transmitted to the projection lens 120 via the total internal reflection prism group 263. In this embodiment, lenses 264 may be appropriately arranged on various light paths of the illumination system 200 to enhance the transmission quality of each light beam.

In the illumination system 200 and the projection device 100 of this embodiment, the light path switching module 400 may be simply used to switch whether the first color light B is transmitted to the wavelength conversion element 230, thereby switching whether the excited light C is generated or not. Therefore, it may possess a shorter response time (i.e., faster switching), and can effectively suppress the phenomenon of color breakup. In one embodiment, referring to FIG. 3 and FIG. 4, the wavelength conversion element 230 includes a first substrate 234 having a first radius R1, and an O-shaped ring phosphor element 232 is disposed on the first substrate 234. The light path switching module 400 includes a second substrate 410 having a second radius R2. The second substrate 410 has a transmissive region W1 and a reflective region W2, where the first radius R1 is greater than the second radius R2, and the rotation speed of the first substrate 234 is less than the rotation speed of the second substrate 410. In other words, since the light path switching module 400 has a smaller radius R1, it may rotate at a higher speed without generating excessive noise, and due to the high rotation speed, it can effectively suppress the phenomenon of color breakup. Additionally, since the wavelength conversion element 230 having the O-shaped ring phosphor element 232 does not need to switch the light beam, it may rotate at a lower speed, thus generating less noise. The use of the wavelength conversion element 230 can also effectively suppress the laser speckle phenomenon.

FIG. 5 is a timing diagram of an illumination system in FIG. 1A and FIG. 1B. Referring to FIG. 1A, FIG. 1B and FIG. 5, FIG. 5 shows the output power diagrams of the red laser diode 312, green laser diode 314, and blue laser diode 316 over time. In this embodiment, during the first time interval S1 (i.e., in sub-time intervals T1, T2, and T4), the first color light B passes through the light path switching module 400 and is incident on the wavelength conversion element 230 (as shown in FIG. 1A). During the second time interval S2 (i.e., in a sub-time interval T3), the first color light B is reflected by the light path switching module 400 and may not be incident on the wavelength conversion element 230 (as shown in FIG. 1B). Specifically, in this embodiment, during the sub-time interval T1, the red laser diode 312 and the blue laser diode 316 are turned on at the same time, while the green laser diode 314 is turned off. At this time, the second color light R and the excited light C are transmitted to the second homogenizing element 240, forming the illumination beam 202. During sub-time interval T2, the green laser diode 314 and the blue laser diode 316 are turned on at the same time, while the red laser diode 312 is turned off. At this time, the third color light G and the excited light C are transmitted to the second homogenizing element 240, forming the illumination beam 202. During the sub-time interval T3, the blue laser diode 316 is turned on and the reflective region W2 of the light path switching module 400 enters the light path of the first color light B, while the green laser diode 314 and the red laser diode 312 are turned off. Therefore, only the first color light B is transmitted to the second homogenizing element 240, forming the illumination beam 202. During the sub-time interval T4, the red laser diode 312, green laser diode 314, and blue laser diode 316 are turned on at the same time. At this time, the second color light R, the third color light G, and the excited light C are transmitted to the second homogenizing element 240, forming the illumination beam 202. The sub-time intervals T1, T2, T3, and T4 may appear repeatedly in sequence over time. Furthermore, the order of appearance of the sub-time intervals T1, T2, T3, and T4 is not limited to that shown in FIG. 5, but may be in various possible orders. It is particularly noted that in other embodiments, during the sub-time intervals T1 and T2, the blue laser diode 316 may be selectively turned off. In yet another embodiment, the sub-time interval T4 may not be included.

FIG. 6 is a side view schematic diagram of a light source module according to another embodiment of the disclosure viewed along the -z direction. Referring to FIG. 6, a light source module 300b of this embodiment may be used to replace the light source module 300 in FIG. 2A and FIG. 2B. The light source module 300b of this embodiment is similar to the light source module 300 in FIG. 2A and FIG. 2B, and the main differences between the two are described as follows. In the light source module 300b of this embodiment, the red laser diode 312, the green laser diode 314, and the blue laser diode 316 are located in different packages. In this embodiment, the light source module 300b includes a dichroic mirror 322b and a reflective mirror 324b. The dichroic mirror 322b is configured to combine the light paths of the second color light R and the third color light G, causing the second color light R and the third color light G to be emitted towards the second direction (i.e., +y direction). In this embodiment, the red laser diode 312 emits the second color light R towards the +y direction, then the second color light R passes through the dichroic mirror 322b and continues to be transmitted towards the +y direction. On the other hand, the green laser diode 314 emits the third color light G towards the +x direction, then the dichroic mirror 322b reflects the third color light G, causing the third color light G to be transmitted towards the +y direction. In another embodiment, the dichroic mirror 322b may also reflect the second color light R and allow the third color light G to pass through, and the positions of the red laser diode 312 and the green laser diode 314 may be interchanged.

The reflective mirror 324b is configured to reflect the first color light B, causing the first color light B to be transmitted towards the first direction (i.e., x direction). In this embodiment, the blue laser diode 316 emits the first color light B towards the +y direction, and the reflective mirror 324b reflects the first color light B, causing the first color light B to be transmitted towards the +x direction. In another embodiment, the blue laser diode 316 may emit the first color light B towards the +x direction. In yet another embodiment, the red laser diode 312, the green laser diode 314, and the blue laser diode 316 may emit light beams towards the +z direction, and use reflective mirrors to reflect the light beams towards the first direction or the second direction.

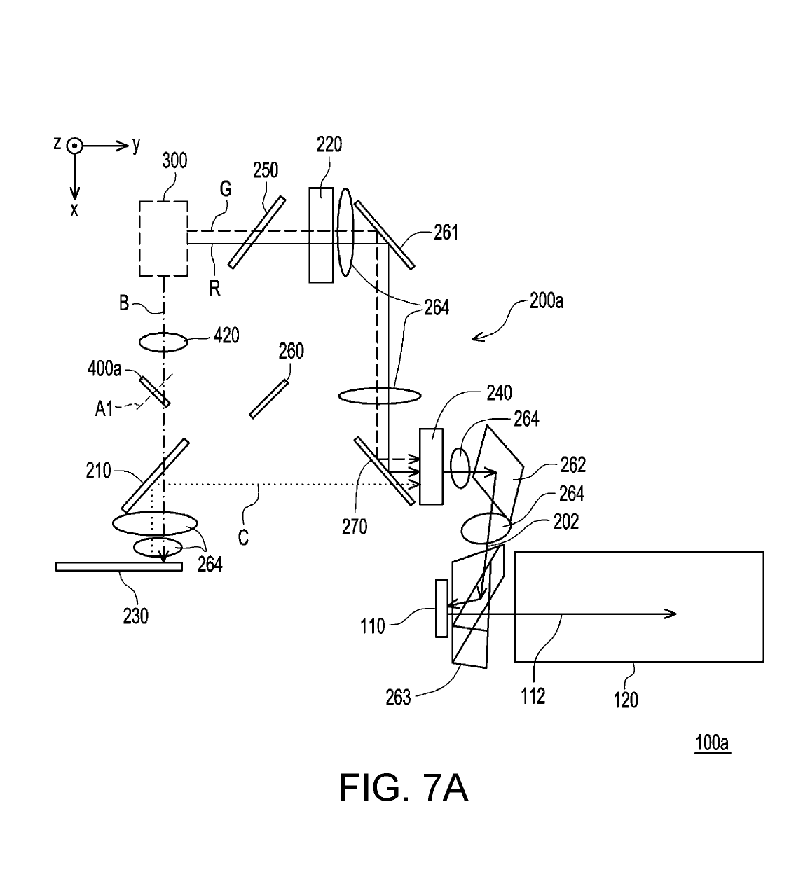

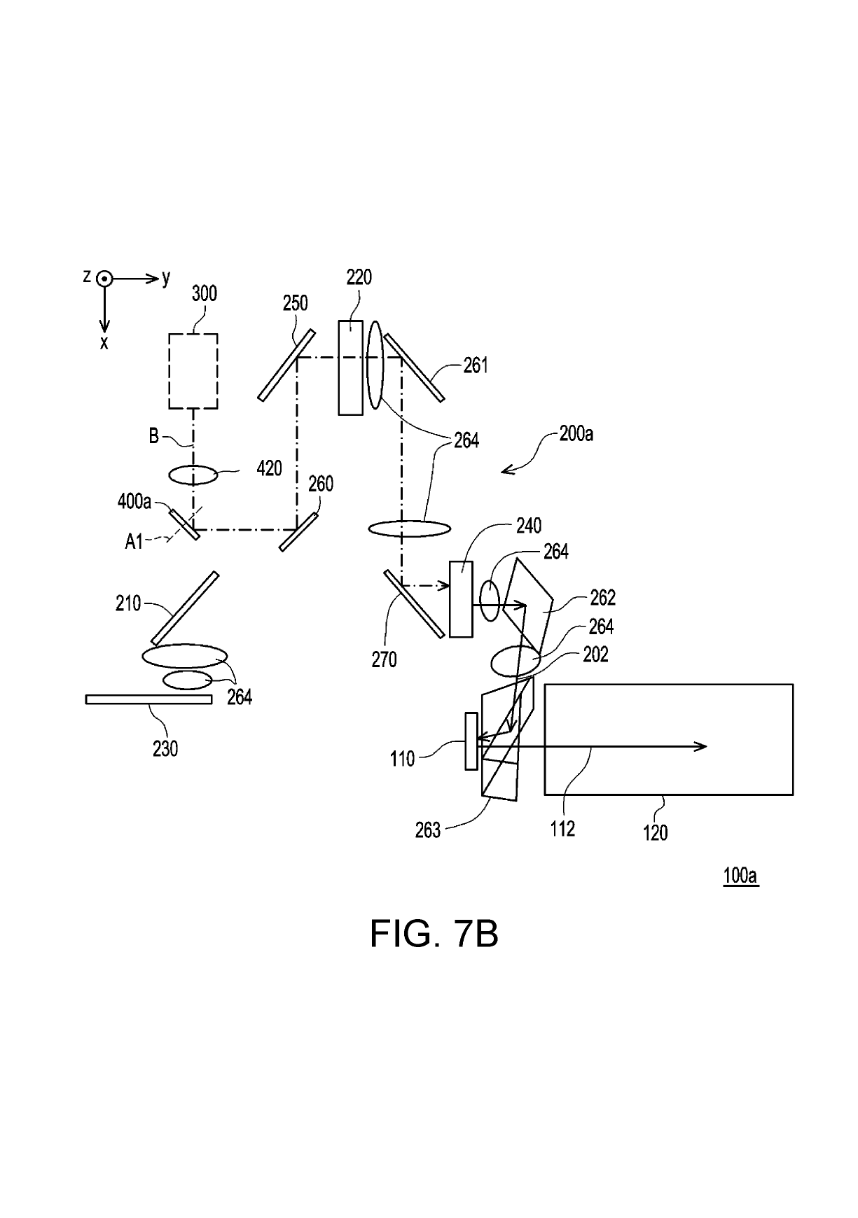

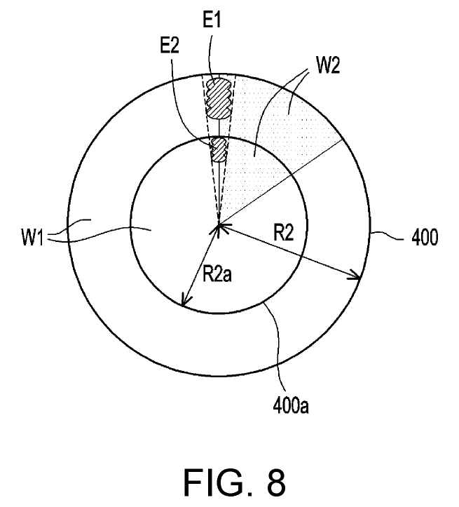

FIG. 7A is a schematic diagram of a light path of a projection device according to another embodiment of the disclosure during the first time interval. FIG. 7B is a schematic diagram of the light path of the projection device of FIG. 7A during the second time interval. FIG. 8 is a comparative schematic diagram of a light path switching module in FIG. 7A and the light path switching module in FIG. 1A. Referring to FIG. 7A, FIG. 7B and FIG. 8, a projection device 100a of this embodiment is similar to the projection device 100 in FIG. 1A and FIG. 1B, and the main differences between the two are described as follows. An illumination system 200a of this embodiment also includes a condensing lens 420 located between a light source module 300 and a light path switching module 400a. In FIG. 1A, a light spot E1 of the first color light B irradiated on the light path switching module 400 is larger, while in this embodiment, the condensing lens 420 may reduce a light spot E2 of the first color light B irradiated on the light path switching module 400a. As a result, in this embodiment, a second radius R2a of the disc face of the light path switching module 400a may be reduced (the second radius R2a is smaller than the second radius R2), because the proportion of the boundary region (i.e., the sector region between the two dashed lines) of the light spot E1 to the entire light path switching module 400 is the same as the proportion of the boundary region of the light spot E2 to the entire light path switching module 400a. Since the second radius R2a of the disc face of the light path switching module 400a may be reduced, the rotation speed of the light path switching module 400a may be higher with less noise, thereby further suppressing the phenomenon of color breaking. Alternatively, in another embodiment, if the light path switching module 400 having the second radius R2 in FIG. 1A is used in combination with the condensing lens 420, the boundary region of the light spot on the light path switching module 400 is reduced due to the smaller light spot E2, thereby effectively reducing the loss of the light spot E2 irradiated on the boundary region.

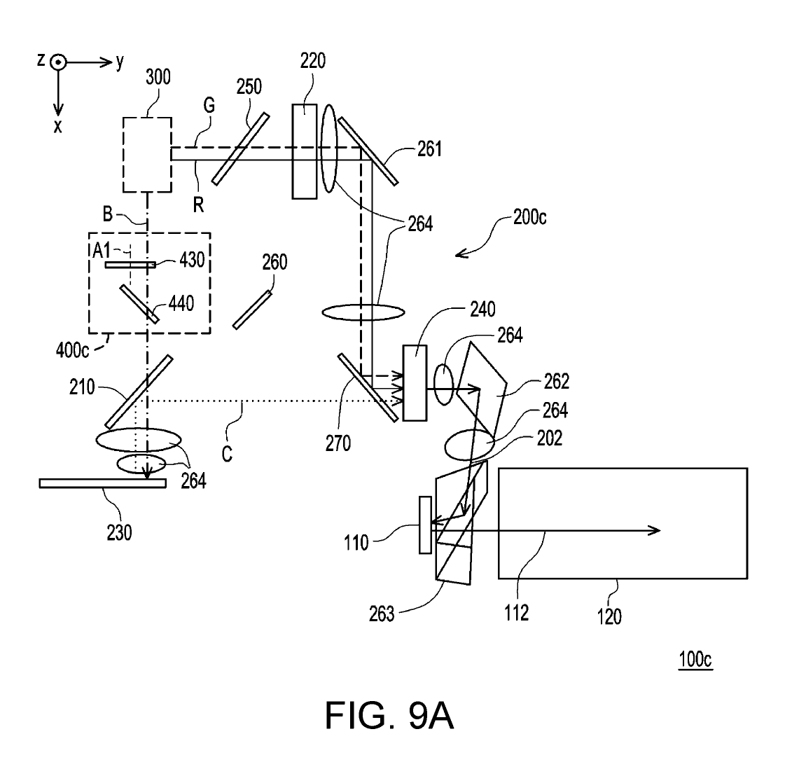

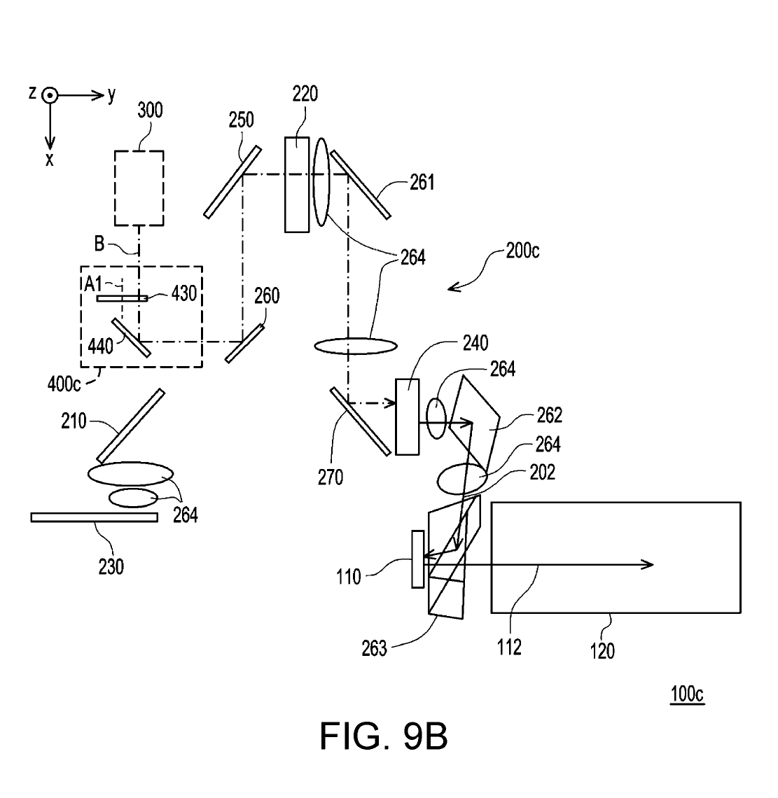

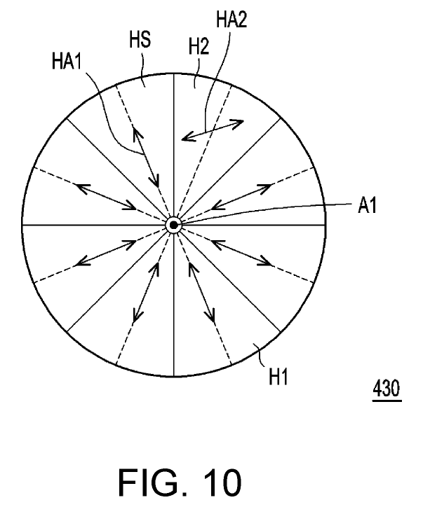

FIG. 9A is a schematic diagram of a light path of a projection device according to another embodiment of the disclosure during the first time interval. FIG. 9B is a schematic diagram of the light path of the projection device of FIG. 9A during the second time interval. FIG. 10 is a front view schematic diagram of a rotating element in FIG. 9A and FIG. 9B. Referring to FIG. 9A, FIG. 9B and FIG. 10, a projection device 100c of this embodiment is similar to the projection device 100 in FIG. 1A and FIG. 1B, and the main differences between the two are described as follows. In an illumination system 200c of this embodiment, a light path switching module 400c includes a rotating element 430 and a polarizing beam splitter 440. The polarizing beam splitter 440 is disposed between the rotating element 430 and the wavelength conversion element 230, the polarizing beam splitter 440 may not be perpendicular to the first direction, for example, the angle between the polarizing beam splitter 440 and the first direction may be 45 degrees. The rotating element 430 includes a first partial region H1 and a second partial region H2. The first partial region H1 is configured to maintain the polarization state of the first color light B, and the second partial region H2 is configured to change the polarization state of the first color light B. The rotating element 430 may possess a substrate, and the surface of the substrate may be perpendicular to the first direction. For example, the first color light beam B emitted by the light source module 300 is originally in P polarization direction with respect to the polarizing beam splitter 440. In the first time interval S1, as the rotating element 430 rotates around the axis A1, the first partial region H1 enters the light path of the first color light beam B, allowing the first color light beam B to pass through and maintain its P polarization direction, then the first color light beam B with P polarization direction may pass through the polarizing beam splitter 440 and be transmitted to the wavelength conversion element 230. In the second time interval S2, as the rotating element 430 rotates around the axis A1, the second partial region H2 enters the light path of the first color light beam B, the second partial region H2 converts the polarization direction of the first color light beam B from P polarization direction to S polarization direction, so that the first color light beam B with S polarization direction may then be reflected by the polarizing beam splitter 440 and be transmitted to a first splitting element 250.

In this embodiment, the first partial region H1 and the second partial region H2 are wave plates, for example, half-wave plates. As shown in FIG. 10, the first partial region H1 includes multiple sub-regions HS, directions of fast axes HA1 of the wave plates of these sub-regions HS are different from each other, and these sub-regions HS are spliced to form the first partial region H1, and the area of the first partial region H1 is larger than the area of the second partial region H2. The direction of the fast axis HA1 of each sub-region HS may be parallel to the central line of each sub-region HS (the central line may be the symmetry line of each sub-region HS). In this embodiment, when the first color light beam B irradiates the center of each sub-region HS, the fast axis HA1 of the wave plate of the sub-region HS is parallel to the P polarization direction of the first color light beam B, therefore the sub-region HS may not change the polarization direction of the first color light beam B. When the first color light beam B irradiates the center of the second partial region H2, a fast axis HA2 of the wave plate (for example, half-wave plate) of the second partial region H2 may form a 45-degree angle with the P polarization direction of the first color light beam B, therefore after the first color light beam B passes through the second partial region H2, its polarization direction may become S polarization direction (which forms a 90-degree angle with the P polarization direction).

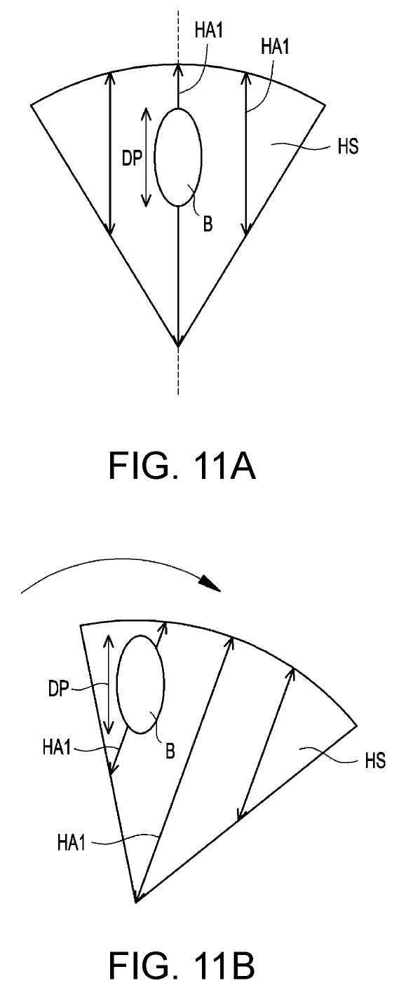

Furthermore, FIG. 11A and FIG. 11B are schematic diagrams of a first color light beam in FIG. 9A illuminating a central region and an edge region of a sub-region, respectively. Referring to FIG. 11A, when the first color light beam B irradiates the center of the sub-region HS, the fast axis HA1 of the wave plate of the sub-region HS may be well parallel to a P polarization direction DP of the first color light beam B, therefore the sub-region HS may not change the polarization direction of the first color light beam B. However, as shown in FIG. 11B, when the first color light beam B irradiates the edge region of the sub-region HS, the P polarization direction DP of the first color light beam B may form a small angle with the fast axis HA1 of the wave plate of the sub-region HS, causing the sub-region HS to rotate the polarization direction of the first color light beam B by a small angle, and unable to perfectly maintain the polarization direction of the first color light beam B in the P polarization direction. To reduce this problem, the number of sub-regions HS may be increased to suppress this phenomenon, or the method of the following embodiment may be adopted.

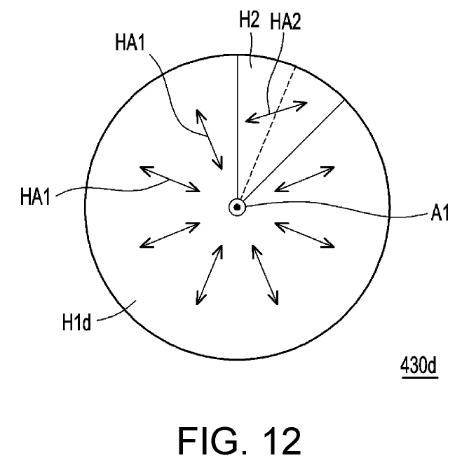

FIG. 12 is a front view schematic diagram of the rotating element in FIG. 9A and FIG. 9B according to another embodiment. Referring to FIG. 9A, FIG. 9B and FIG. 12, a rotating element 430d of this embodiment is similar to the rotating element 430 in FIG. 10, and the main difference between the two lies in that the direction of the fast axis HA1 of the wave plate of a first partial region H1d of the rotating element 430d in this embodiment is distributed in a radial form (for example, the direction of the fast axis HA1 at each position is parallel to the radial direction at each position respectively) and the first partial region H1d is continuously formed in one piece. In this way, regardless of the angle to which the rotating element 430d rotates the first partial region H1d, the fast axis HA1 at the position of the first partial region H1d irradiated by the first color light B may always be parallel to the P polarization direction of the first color light beam B, and may well maintain the P polarization direction of the first color light beam B.

In summary, the illumination system and projection device of the embodiments of this disclosure possess at least one of the following advantages. In the illumination system and projection device of the embodiments of this disclosure, a light path switching module is adopted. The light path switching module is configured to cause the first color light to pass through during a first time interval, and reflect the first color light during a second time interval, where the first time interval and the second time interval do not overlap. After passing through the light path switching module, the first color light irradiates the wavelength conversion element and generates an excited light. After being reflected by the light path switching module, the first color light is transmitted to the first beam splitting element, and may not irradiate the wavelength conversion element. Therefore, the illumination system and projection device of the embodiments of this disclosure may simply use the light path switching module to switch whether the excited light is generated or not. Therefore, it may possess a shorter response time (i.e., faster switching), and can effectively suppress the phenomenon of color breakup. Additionally, since the wavelength conversion element having the O-shaped ring phosphor element does not need to switch the light beam, it may rotate at a lower speed, thus generating less noise. The use of the wavelength conversion element can also effectively suppress the laser speckle phenomenon.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations may be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second’, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which may allow a searcher to quickly ascertain the subject matter of the technical disclosure of any patent issued from this disclosure. It is submitted with the understanding that it may not be used to interpret or limit the scope or meaning of the claims. Any advantages and benefits described may not apply to all embodiments of the disclosure. It should be appreciated that variations may be made in the embodiments described by persons skilled in the art without departing from the scope of the disclosure as defined by the following claims. Moreover, no element and component in the disclosure is intended to be dedicated to the public regardless of whether the element or component is explicitly recited in the following claims.

What is claimed is:

1. An illumination system, comprising a light source module, a wavelength conversion element, a light path switching module, a first beam splitting element, and a second beam splitting element, wherein:
the light source module is configured to emit first color light, second color light, and third color light, wherein dominant wavelengths of the first color light, the second color light, and the third color light are different from each other;
the wavelength conversion element has an O-shaped ring phosphor element;
the light path switching module is configured to cause the first color light to pass through during a first time interval, and reflect the first color light during a second time interval, wherein the first time interval and the second time interval do not overlap;
the first beam splitting element is configured to cause the second color light and the third color light to pass through, and reflect the first color light, wherein
the first color light is transmitted towards a first direction to the light path switching module, and the second color light and the third color light are transmitted towards a second direction to the first beam splitting element;
after passing through the light path switching module, the first color light irradiates the wavelength conversion element to generate excited light;
after being reflected by the light path switching module, the first color light is transmitted to the first beam splitting element, and does not irradiate the wavelength conversion element; and
the second beam splitting element is configured to cause the excited light to pass through, and reflect the first color light, the second color light, and the third color light.

2. The illumination system according to claim 1, wherein the light path switching module comprises a transmissive region for causing the first color light to pass through and a reflective region for reflecting the first color light.

3. The illumination system according to claim 2, further comprising a condensing lens located between the light source module and the light path switching module.

4. The illumination system according to claim 1, wherein the light path switching module comprises a rotating element and a polarizing beam splitter, the polarizing beam splitter is disposed between the rotating element and the wavelength conversion element, the rotating element comprises a first partial region and a second partial region, the first partial region is configured to maintain a polarization state of the first color light, and the second partial region is configured to change the polarization state of the first color light.

5. The illumination system according to claim 4, wherein the first partial region comprises a plurality of sub-regions, fast axes of wave plates of the sub-regions are different from each other, and the sub-regions are spliced to form the first partial region, and an area of the first partial region is larger than an area of the second partial region.

6. The illumination system according to claim 4, wherein a direction of a fast axis of a wave plate in the first partial region is distributed in a radial form.

7. The illumination system according to claim 1, wherein the illumination system further comprises a third beam splitting element located between the wavelength conversion element and the light path switching module, the third beam splitting element causes one of the first color light and the excited light to pass through, and reflects the other of the first color light and the excited light.

8. The illumination system according to claim 1, wherein the light source module comprises:
a red laser diode, a green laser diode, and a blue laser diode located in a same package, wherein the blue laser diode is configured to emit the first color light, the red laser diode is configured to emit the second color light, and the green laser diode is configured to emit the third color light;
a first reflector and a dichroic mirror, configured to cause the second color light and the third color light to be emitted towards the second direction;
a second reflector, configured to cause the first color light to be emitted towards the first direction; and
a reflector group, configured to translate the first color light from the second reflector.

9. The illumination system according to claim 1, wherein the light source module comprises:
a red laser diode, configured to emit the second color light;
a green laser diode, configured to emit the third color light;
a blue laser diode, configured to emit the first color light;
a dichroic mirror, configured to combine light paths of the second color light and the third color light, causing the second color light and the third color light to be emitted towards the second direction; and
a reflective mirror, configured to reflect the first color light, causing the first color light to be emitted towards the first direction, wherein the red laser diode, the green laser diode, and the blue laser diode are located in different packages.

10. A projection device, comprising an illumination system, a light valve, and a projection lens, wherein:
the illumination system comprises a light source module, a wavelength conversion element, a light path switching module, a first beam splitting element, and a second beam splitting element, wherein:
the light source module is configured to emit first color light, second color light, and third color light, wherein dominant wavelengths of the first color light, the second color light, and the third color light are different from each other;
the wavelength conversion element has an O-shaped ring phosphor element;
the light path switching module is configured to cause the first color light to pass through during a first time interval, and reflect the first color light during a second time interval, wherein the first time interval and the second time interval do not overlap;
the first beam splitting element is configured to cause the second color light and the third color light to pass through, and reflect the first color light, wherein
the first color light is transmitted towards a first direction to the light path switching module, and the second color light and the third color light are transmitted towards a second direction to the first beam splitting element;
after passing through the light path switching module, the first color light irradiates the wavelength conversion element to generate excited light;
after being reflected by the light path switching module, the first color light is transmitted to the first beam splitting element, and does not irradiate the wavelength conversion element; and
the second beam splitting element is configured to cause the excited light to pass through, and reflect the first color light, the second color light, and the third color light;
the light valve is disposed on light paths of the first color light, the excited light, the second color light, and the third color light, and is configured to convert the first color light, the excited light, the second color light, and the third color light into an image beam; and
the projection lens is disposed on a light path of the image beam.

11. The projection device according to claim 10, wherein the light path switching module comprises a transmissive region for causing the first color light to pass through and a reflective region for reflecting the first color light.

12. The projection device according to claim 11, wherein the illumination system comprises a condensing lens located between the light source module and the light path switching module.

13. The projection device according to claim 10, wherein the light path switching module comprises a rotating element and a polarizing beam splitter, the polarizing beam splitter is disposed between the rotating element and the wavelength conversion element, the rotating element comprises a first partial region and a second partial region, the first partial region is configured to maintain a polarization state of the first color light, and the second partial region is configured to change the polarization state of the first color light.

14. The projection device according to claim 13, wherein the first partial region comprises a plurality of sub-regions, fast axes of wave plates of the sub-regions are different from each other, and the sub-regions are spliced to form the first partial region, and an area of the first partial region is larger than an area of the second partial region.

15. The projection device according to claim 13, wherein a direction of a fast axis of a wave plate in the first partial region is distributed in a radial form.

16. The projection device according to claim 10, wherein the illumination system further comprises a third beam splitting element located between the wavelength conversion element and the light path switching module, the third beam splitting element causes one of the first color light and the excited light to pass through, and reflects the other of the first color light and the excited light.

17. The projection device according to claim 10, wherein the light source module comprises:
a red laser diode, a green laser diode, and a blue laser diode located in a same package, wherein the blue laser diode is configured to emit the first color light, the red laser diode is configured to emit the second color light, and the green laser diode is configured to emit the third color light;
a first reflector and a dichroic mirror, configured to cause the second color light and the third color light to be emitted towards the second direction;
a second reflector, configured to cause the first color light to be emitted towards the first direction; and
a reflector group, configured to translate the first color light from the second reflector.

18. The projection device according to claim 10, wherein the light source module comprises:
a red laser diode, configured to emit the second color light;
a green laser diode, configured to emit the third color light;
a blue laser diode, configured to emit the first color light;
a dichroic mirror, configured to combine light paths of the second color light and the third color light, causing the second color light and the third color light to be emitted towards the second direction; and
a reflective mirror, configured to reflect the first color light, causing the first color light to be emitted towards the first direction, wherein the red laser diode, the green laser diode, and the blue laser diode are located in different packages.
